(19) United States
(12) Patent Application Publication
(10) Pub. No.: US 2012/0114727 A1
(43) Pub. Date: May 10, 2012

(54) INSECTICIDAL SHEET-LIKE STRUCTURE FOR PROTECTING HUMANS AND DOMESTIC ANIMALS

(75) Inventors: Hartmut Leininger, Neustadt (DE); Susanne Stutz, Weinheim (DE); Ulrich Karl, Grunstadt (DE)

(73) Assignee: BASF SE, Ludwigshafen (DE)

(21) Appl. No.: 13/382,711

(22) PCT Filed: Jul. 5, 2010
(86) PCT No.: PCT/EP2010/059557

§ 371 Date: Jan. 6, 2012

(30) Foreign Application Priority Data
Jul. 9, 2009 (EP) 09165019.2
Aug. 13, 2009 (EP) 09167790.6

(51) Int. Cl. A01N 43/36; A01P 7/04; A01N 25/08

(52) U.S. Cl. 424/411; 514/427; 424/409

(57) ABSTRACT

A sheet-like structure, in particular a net, finished with an insecticidal mixture comprising
a) chlorfenapyr and
b) one or more pyrethroids from the group consisting of
   alpha-cypermethrin (b1), deltamethrin (b2), permethrin (b3) and lambda-cyhalothrin (b4),
      in an amount of (in each case relative to the sheet-like structure)
   a) 50 to 150 mg/m² chlorfenapyr;
   b1) 50 to 150 mg/m² alpha-cypermethrin;
   b2) 15 to 45 mg/m² deltamethrin;
   b3) 50 to 750 mg/m² permethrin;
   b4) 5 to 30 mg/m² lambda-cyhalothrin,
      is suitable for controlling harmful insects in buildings and for protecting humans and domestic animals from such harmful insects and from vector-transmitted diseases which are transmitted by the harmful insects.

The invention relates to a sheet-like structure, in particular to a net, which has been coated with a pyrethroid-comprising active compound mixture for the protection of humans and domestic animals from harmful insects, in particular mosquitoes, and to a method of protecting humans and domestic animals from harmful insects and from diseases transmitted by them.

Means for controlling vector-transmitted diseases such as malaria, yellow fever, dengue fever, lymphatic filariosis and leishmaniosis which have proven particularly effective are insecticide-finished mosquito nets. For example, one of the columns of the global “Roll Back Malaria Partnership” project, besides spray applications of insecticides to internal walls of dwellings, is the use of such nets, which is recommended by the WHO (World Health Organization). In order to ensure efficient protection over a prolonged period of time, the nets must be finished in such a way that the insecticidal activity is not lost even after a substantial number of washes. Suitable nets which have been treated with specific insecticide/binder combinations are also referred to as LLINs (Long Lasting Insecticidal Nets).

Insecticides which are currently being used in this context are virtually exclusively pyrethroids since this class of insecticides not only has a high lethal effect on the insects combined with low mammalian toxicity, but the insect is also put out of action as the result of rapid paralysis before it can bite and thus transmit the disease (known as the knock-down effect).

However, the fact that pyrethroids have been used for many years and are increasingly being used also means that there is a risk of an increased onset of resistances, especially since these insecticides are also employed in agriculture for controlling crop pests. Thus, for example, pyrethroid resistance has arisen in Anopheles gambiae in West Africa and East Africa and in Anopheles funestus in Southern Africa.

The use of alternative insecticides, if appropriate as a mixture with pyrethroids, is being discussed for breaking and avoiding the development of resistances. One possible candidate in this context is chlorfenapyr, which has a good activity against anopheles mosquitoes, only a low degree of toxicity to humans and a mechanism of action different to that of pyrethroids (decoupling of oxidative phosphorylation in mitochondria, mitochondrial electron transport inhibitor, METI) (see, for example, R. N'Guessan et al., Acta Tropica 102 (2007) 69-78; F. W. Mosha et al., Tropical Medicine and International Health 13(5) 2008 644-652; R. N'Guessan et al., Tropical Medicine and International Health 14(4) (2009)1-7). Combinations of chlorfenapyr and a pyrethroid are also proposed in the above-mentioned documents.

A problem when using active compound combinations is that the total amount of insecticides employed is generally markedly increased, which, in general, is undesired for economical, ecological and toxicological reasons.

It has now been found that combining chlorfenapyr with certain pyrethroids allows considerably to reduce not only the amount of chlorfenapyr, but also the amount of the pyrethroids employed (compared to using the pure active compound) without reducing the activity, including the activity against pyrethroid-resistant harmful insects.

This could not have been expected since chlorfenapyr displays a lower knock-down effect, which effect, however, is of particular importance for the protection against malaria. Only rapid paralysis ensures that the mosquito can no longer bite and thus possibly transmit the disease. Surprisingly, this effect is retained even though the amount of pyrethroid is markedly reduced over the application on its own. This even applies to insects which feature a pyrethroid resistance.

The invention therefore relates to a sheet-like structure finished with an insecticidal mixture comprising
a) chlorfenapyr and
b) one or more pyrethroids from the group consisting of alpha-cypermethrin (b1), deltamethrin (b2), permethrin (b3) and lambda-cyhalothrin (b4),
   in an amount of (in each case relative to the sheet-like structure)
   a) 50 to 150 mg/m² chlorfenapyr;
   b1) 50 to 150 mg/m² alpha-cypermethrin;
   b2) 15 to 45 mg/m² deltamethrin;
   b3) 50 to 750 mg/m² permethrin;
   b4) 5 to 30 mg/m² lambda-cyhalothrin.

The invention furthermore relates to the use of the sheet-like structure according to the invention for protecting humans and domestic animals from harmful insects and from vector-transmitted diseases.

The invention likewise relates to methods of controlling harmful insects and of protecting humans and domestic animals from harmful insects and/or vector-transmitted diseases, in which methods a sheet-like structure according to the invention is applied in a building. The sheet-like structure according to the invention is distinguished by simple production and, in particular in the form of nets, simple use. Nets according to the invention also have a good insecticidal activity, including a good insecticidal activity against pyrethroid-resistant harmful insects, even after repeated washing. The insecticidal sheet-like structures feature favorable toxicological data and permit an effective control of harmful insects, including pyrethroid-resistant harmful insects.

### Insecticides

According to the invention, there is employed a mixture comprising, preferably essentially consisting of, in particular consisting of, chlorfenapyr and at least one of the pyrethroids mentioned.

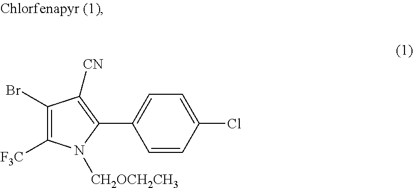

(IUPAC name: 4-Bromo-2-(4-chlorophenyl)-1-ethoxymethyl(5-trifluoromethylpyrrole-3-carbonitrile)) is commercially available from BASF SE and is described for example in: C. D. S. Tomlin (Ed.), The Pesticide Manual, 14th ed., British Crop Protection Council, Alton (UK) 2006.

The following are employed as pyrethroid: alpha-cypermethrin, deltamethrin, permethrin and/or lambda-cyhalothrin.

Especially preferred are alpha-cypermethrin, deltamethrin and permethrin.

Very especially preferred is alpha-cypermethrin.

Preferred is the use of a binary mixture of chlorfenapyr and one of the pyrethroids mentioned, but it is also possible to employ chlorfenapyr in a mixture with a plurality of, preferably two, pyrethroids.

The active compounds mentioned are known and are commercially available; chlorfenapyr and alpha-cypermethrin, for example, are commercially available from BASF SE, Ludwigshafen, Germany. The active compounds are described for example in The Pesticide Manual (see above).

The amounts of insecticide per square meter of sheet-like structure are generally and preferably as follows:

chlorfenapyr (a): 50 to 150 mg/m², preferably 70 to 130 mg/m², especially preferably 90 to 110 mg/m²;
alpha-cypermethrin: 50 to 150 mg/m², preferably 70 to 130 mg/m², especially preferably 90 to 110 mg/m²;
deltamethrin: 15 to 45 mg/m², preferably 20 to 40 mg/m², especially preferably 25 to 35 mg/m²;
permethrin: 50 to 750 mg/m², preferably 75 to 650 mg/m², especially preferably 100 to 550 mg/m²; lambda-cyhalothrin: 5 to 30 mg/m², preferably 7.5 to 25 mg/m², especially preferably 10 to 20 mg/m².

Thus, the mixing ratio chlorfenapyr:pyrethroid is, generally, 0.06-30:1, preferably 0.1-10:1, especially preferably 0.1-5:1, depending on the active compound.

The particle size of the insecticides in the aqueous formulation is generally from 50 nm to 20 μm, preferably 50 nm to 8 μm, especially preferably 50 nm to 4 μm, in particular 50 nm to 500 nm.

### Sheet-Like Structure

Examples of suitable sheet-like structures are textile materials, nontextile plastic materials, paper, leather, man-made leather, films and other, preferably flexible, materials.

The sheet-like structure employed preferably takes the form of a textile material, in particular of nets made of textile fibers. They can take the form of nets made of natural fibers or synthetic fibers. Of course, they can also take the form of mixtures of two or more different fibers. Examples of natural fibers comprise cotton fibers, jute fibers or linen fibers. Preferably, they take the form of synthetic fibers made of suitable polymers. Examples comprise polyamides, polyesters, polyacrylonitrile or polyolefins. Preferably, they take the form of polyamides, polyolefins and polyesters, especially preferably polyolefins, in particular polypropylene or polyethylene, and polyesters. Very especially preferred are polyester fibers, in particular polyethylene terephthalate (PET).

The fibers may take the form of monofilaments, oligofilaments or multifilaments, which may be smooth or textured.

Polypropylene and polyethylene may take the form of polypropylene or polyethylene homopolymers. However, they may also take the form of copolymers, which comprise small amounts of other comonomers in addition to the ethylene or propylene. Suitable comonomers may take the form of, in particular, other olefins such as, for example, ethylene or propylene and but-1-ene, but-2-ene, isobutene, pent-1-ene, hex-1-ene, hept-1-ene, oct-1-ene, styrene or α-methylstyrene, dienes and/or polyenes. In general, the comonomers in the polyethylene or polypropylene amount to no more than 20% by weight, preferably no more than 10% by weight. The nature and amount of the comonomers are selected by the skilled worker as a function of the desired fiber properties.

Products which are especially preferred for the production of fibers are relatively high-molecular-weight, viscous products which are characterized in the customary manner by their melt flow index (determined as specified in ISO 1133). Preferably, they may take the form of at least one polypropylene or polyethylene with a melt flow index MFR (230° C., 2.16 kg) of from 0.1 to 60 g/10 min. Preferably, they take the form of polypropylene with a melt flow index MFR (230° C., 2.16 kg) of from 1 to 50 g/10 min, especially preferably from 10 to 45 g/10 min and for example 30 to 40 g/10 min. Such types of polypropylene are particularly suitable for the production of fibers. Of course, a mixture of a plurality of different types of polypropylene may also be employed.

Depending on the nature of the net, the textile fibers have a thickness of from 0.05 to 0.6 mm, preferably 0.1 mm to 0.4 mm, especially preferably 0.12 to 0.35 mm and very especially preferably 0.2 to 0.3 mm.

The textile material is employed for example in the form of coverings or covers, for example for bed covers, mattresses, pillows, curtains, wall coverings, carpets, curtains for windows, cupboards and doors, ceilings, tarpaulins and tent cloths. Preferred are nets, in particular mosquito nets, for example bed nets for the protection against mosquitoes and other harmful insects.

The preferred nets which are employed preferably have a mesh pattern with an even number of corners. In this context, the nets may consist preferably of a simple type of mesh only, for example of quadrangular meshes only or of hexagonal meshes only, or else they may also comprise two or more types of different meshes, for example a combination of octagonal and quadrangular meshes.

In this context, the meshes of the net should preferably be essentially of the same type, i.e. while the net may indeed feature minor deviations in respect of shape and size of the meshes, the values will not vary unduly around the means.

Suitable mesh sizes (length of the side of a square mesh) are in the range of 5 mm, preferably 2.5 mm, in particular 1.5 mm as the upper limit and 0.1 mm, preferably 0.25 mm, especially preferably 0.5 mm, in particular 0.7 mm as the lower limit.

The meshes of the net are preferably selected from the group of quadrangular, hexagonal or octagonal meshes.

The quadrangular meshes take the form of meshes in the shape of a parallelogram with the sides a and b. Naturally, the term “parallelogram” also comprises the terms “rectangle” and “square”. The smaller angle between the two sides of the parallelogram will, as a rule, be between 60 and 90°. In the borderline case of 90°, the parallelogram takes the form of a rectangle. In the borderline case a=b and 90°, it takes the form of a square. The parallelogram furthermore has a height hₐ. In the case of a rectangle or a square, the height hₐ corresponds to the length of side a. Square meshes are particularly preferred.

In the case of the hexagonal meshes, three pairs of sides a, b and c, which run in each case parallel to each other, are arranged at the distances hₐ, h_{b} and h_{c}. In the case of the octagonal meshes, four pairs of sides a, b, c and d, which run in each case parallel to each other, are arranged at the distances hₐ, h_{b}, h_{c} and h_{d}. A person skilled in the art knows that no continuous patterns can be established with octagons. A net which comprises octagonal meshes will, therefore, additionally comprise at least one second type of mesh. These may take the form of quadrangular meshes.

In a specific embodiment of the invention, the height hₐ in the parallelogram, the hexagon and the octagon is from 0.1 to 0.99 mm, preferably from 0.1 to 0.9 mm, especially preferably from 0.12 to 0.8 mm and very especially preferably from 0.25 to 0.7 mm.

In the parallelogram, the length-to-height ratio b/hₐ is from 1:1 to 5:1, preferably from 1:1 to 4:1 and especially preferably from 2:1 to 4:1. Therefore, in the case of a ratio b/hₐ of 1:1, the meshes may take the form of a square with a side length of from 0.1 to 0.99 mm. In the case of a wider ratio of b/hₐ, they take the form of a structure which is elongated along one axis. By virtue of the distance hₐ of no more than 0.99 mm, even smaller insects are efficiently prevented from passing across the net, while the length can indeed be greater than 0.99 mm, so that the air permeability of the net is not unduly hindered.

In the case of a hexagon, the ratio ((h_{b}+h_{c})/2)/hₐ is from 1:1 to 5:1, preferably from 1:1 to 4:1 and especially preferably from 2:1 to 4:1. Here, the situation is analogous to the parallelogram. A ratio of 1:1 will result in a regular hexagon with three equal sides, each of which have an equal distance of no more than 0.99 mm to each other. A greater ratio ((h_{b}+h_{c})/2)/hₐ results in a hexagon which is elongated along one axis. The effect regarding permeability to insects and air is as in the case of the parallelogram.

In the case of an octagon, the ratio ((h_{b}+h_{c}+h_{d})/3)/hₐ is from 1:1 to 5:1, preferably from 1:1 to 4:1 and especially preferably from 2:1 to 4:1. Here, the ratios are analogous to the parallelogram. A ratio of 1:1 will result in a regular octagon with four equal sides, each of which have an equal distance of no more than 0.99 mm to each other. A greater ratio ((h_{b}+h_{c}+h_{d})/3)/hₐ results in an octagon which is elongated along one axis. The effect regarding permeability to insects and air is as in the case of the parallelogram.

Besides quadrangular and hexagonal meshes, it is also possible, for example, to employ combinations of quadrangular and octagonal meshes in this embodiment, or to vary the shape and size of the meshes in parts of the net. For example, the edges of the net can be knitted more densely, or else thicker textile fibers, which are also made of a different polymer, may be knitted in at certain distances in order to stabilize the net.

The terms “height” and “length” refer to the open area of each mesh without taking into consideration the fibers or the coated fibers. Analogously, the term “mesh size” for the purposes of the present invention means the hole size of the meshes, i.e. the open area of each mesh without taking into consideration the fibers or the coated fibers.

Textile net materials according to this embodiment of the invention are described in European Patent Application 08161456.2.

The thickness of the fibers used for the production of the textile material according to the invention, in particular of the nets according to the invention, is selected by the skilled worker depending on the desired properties of the net. As a rule, the thicker the fibers, the greater the mechanical stability of the net; on the other hand, the proportion of open area in comparison with the proportion of the fiber-covered area will decrease with decreasing mesh size. As a rule, the fiber thickness should be such that the open area of the net will be at least 20%, preferably at least 40% and in particular at least 50% of the net. Nets of the abovementioned type are commercially available.

The nets used can preferably take the form of single-layer nets. However, they may also take the form of what are known as spacer fabrics, where two nets are connected to one another with the aid of individual yarns to form a double layer.

### Finishing

The term “finishing” means according to the invention any type of treatment of the sheet-like structure with the insecticide mixture, by means of which treatment a homogeneous distribution of the mixture on or in the sheet-like structure is achieved. In this context, homogeneous means that the concentration of a certain insecticide is essentially the same at any point of the areas.

In one embodiment, finishing is effected by coating the sheet-like structure or, preferably, monofilaments or multifilaments or fibers of which the sheet-like structure is produced with the insecticide mixture together with a binder (variant A).

In a further embodiment, finishing is effected by admixing the insecticide mixture to a polymer and coextruding the polymer and the insecticide mixture to give a monofilament which is processed to give the sheet-like structure according to the invention (variant B).

Finishing by Coating with an Insecticide-Mixture-Comprising Binder (Variant A)

The function of the binder is to fix the insecticide mixture on the monofilaments or multifilaments or fibers of which the sheet-like structure is produced, or on the finished sheet-like structure (“end of line coating”) (hereinbelow described with reference to a net). The result achieved hereby is that the active compound cannot be leached, or at least only very slowly.

The polymeric binder may, in principle, take the form of any binder with the proviso that the binders are capable of fixing the insecticide mixture in particular to textile materials. Binders which are therefore preferred are those known from the field of textile finishing and textile coating. Naturally, it is also possible to employ a mixture of a plurality of different binders.

Examples comprise homo- or copolymers comprising (meth)acrylates, or polyurethanes, polyisocyanurates or waxes, such as polyethylene waxes.

For example, they may be binders which can be obtained by polymerization of ethylenically unsaturated monomers, preferably at least one monomer selected from the group consisting of (meth)acrylates, in particular C₁- to C₁₂-esters of (meth)acrylic acid, (meth)acrylates having crosslinking groups, (meth)acrylic acid, maleic acid or maleic esters, acrylonitrile, styrene, vinyl acetate, vinyl alcohol, ethylene, propylene, allyl alcohol or vinyl chloride.

In a preferred embodiment of the invention, this is a copolymer of ethylenically unsaturated monomers which comprises, as monomers, 50 to 95% by weight of at least one (meth)acrylate (A) of the general formula H₂C═CHR¹—COOR², where R¹ is H or methyl and R² is an aliphatic, linear or branched hydrocarbon radical having 1 to 12 carbon atoms, preferably 2 to 10 carbon atoms. R¹ is preferably H. Examples of suitable radicals R² comprise in particular methyl, ethyl, n-butyl or 2-ethylhexyl radicals, preferably ethyl, n-butyl or 2-ethylhexyl radicals. Moreover, the copolymer comprises 1 to 20% by weight of (meth)acrylic acid or (meth)acrylic acid derivatives (B) with additional functional groups. This may take the form in particular of a (meth)acrylic ester and/or (meth)acrylamides. The functional groups serve to bind the binder to the nets and can furthermore be used for crosslinking. For example, they may take the form of ω-hydroxyalkyl (meth)acrylic esters, (meth)acrylic esters having epoxy groups such as, for example, glycidyl esters, (meth)acrylamides or derivatives thereof such as, for example, (meth)acrylic acid methylolamide of the formula H₂C═CH(CH₃)—CO—HN—CH₂—OH. It is at the same time possible to employ further ethylenically unsaturated, preferably monoethylenically unsaturated, monomers (C) which differ from A and B, for example acrylonitrile or styrene. As a rule, the amount of further monomers is from 0 to 30% by weight. Especially preferred is a binder which comprises 70 to 90% by weight of an acrylic ester of the formula H₂C═CH₂—COOR², where R² comprises 4 to 8 C atoms, and which is preferably n-butyl and/or 2-ethylhexyl, and furthermore 10 to 20% by weight of acrylonitrile, 1 to 10% by weight of (meth)acrylic acid or a (meth)acrylic acid derivative which has functional groups, in particular (meth)acrylic acid methylolamide.

The abovementioned preferred binders can preferably be prepared by methods known to the skilled worker, preferably by means of emulsion polymerization. Preferably an acrylate binder, in particular a copolymer, can be obtained by emulsion polymerization of the components B1 to B4, and optionally B5.

As component B1, one or more, preferably 1, 2 or 3, especially preferably 1, (meth)acrylate(s) of the formula (I)

H₂C═CR¹—COOR² (I)

is/are employed, where the symbols have the following meanings:
R¹ is H or CH₃, preferably H, and
R² is C₁-C₁₀-alkyl, preferably methyl, ethyl, n-propyl, i-propyl, n-butyl, i-butyl, sec-butyl, t-butyl, n-pentyl, sec-pentyl, neopentyl, 1,2-dimethylpropyl, i-amyl, n-hexyl, i-hexyl, n-heptyl, n-octyl, 2-ethylhexyl, n-nonyl or n-decyl, especially preferably methyl, ethyl, n-butyl or 2-ethylhexyl, very especially preferred are ethyl, n-butyl or 2-ethylhexyl.

Preferred as component B1 are methyl acrylate, ethyl acrylate, n-butyl acrylate, 2-ethylhexyl acrylate and methyl methacrylate. Also preferred are butyl acrylate on its own or in admixture with methyl methacrylate or ethyl acrylate. Especially preferred is n-butyl acrylate.

Substances which are employed as component B2 are at least one monomer from the group consisting of N-methylolacrylamide, N-methylolmethacrylamide, N,N′-bismethylolmaleic diamide and N,N′-bismethylolfumaric diamide.

Preferred are N-methylolacrylamide and N-methylolmethacrylamide, in particular N-methylolmethacrylamide.

Substances which are employed as component B3 are one or more monomers, preferably one or two monomers selected from the group consisting of acrylic acid, methacrylic acid, vinylsulfonic acid, maleic acid and fumaric acid. Preferred are acrylic acid and methacrylic acid; acrylic acid is especially preferred.

Substances which are employed as component B4 are one or more monomers, preferably one or two monomers, selected from groups B4A and/or B4B.

Monomers of group B4A are those of the formula (II) and/or (III)

H₂C═CR³X (II)

ZHC═CHZ (III)

where the symbols have the following meanings:
R³ is H or CH₃, preferably H;
X is Z, —CO—NH—CH₂—NH—CO—CR³═CH₂ or
   COO—CH₂—CO—CH₂—COOR⁴, preferably Z;
Z equals CONH₂, CONH—CH₂—OR⁵, COO—Y—OH, COO-glycidyl, CHO, CO—Y—OH, preferably CONH₂;
Y is C₁-C₈-alkylene, preferably C₂-C₆-alkylene, and
   R⁴, R⁵ are identical or different and are a linear or branched C₁-C₁₀-alkyl group;
   and (meth)acrylic-modified benzophenones, as described, for example, in EP-A 0 346 734.

Preferred as monomers from group B4A are acetoacetyl acrylate, acetoacetyl methacrylate, acrylamide, methacrylamide, maleic diamide, N-methoxymethylacrylamide, N-n-butoxymethylacrylamide, 3-hydroxypropyl acrylate, 3-hydroxypropyl methacrylate, 4-hydroxybutyl acrylate, 4-hydroxybutyl methacrylate, 6-hydroxyhexyl acrylate, 6-hydroxyhexyl methacrylate, 2-hydroxy-3-chloropropyl acrylate, 3-hydroxy-3-chloropropyl methacrylate, glycidyl acrylate and glycidyl methacrylate. Especially preferred are acrylamide, 3-hydroxypropyl methacrylate, butanediol monoacrylate acetylacetate, glycidyl methacrylate, and 4-acryloxybenzophenone.

Substances which are employed as monomers from group B4B are allyl acrylate, methallyl acrylate, allyl methacrylate, methallyl methacrylate, diallyl maleate, dimethylallyl maleate, allyl fumarate, methallyl fumarate, diallyl phthalate, dimethylallyl phthalate, diallyl terephthalate, dimethallyl terephthalate, p-divinylbenzene, butane-1,4-diol diallyl ether and butane-1,4-diol dimethylallyl ether.

Preferred monomers of group B4 are those of group B4A, the use of one or two monomers from among this group being preferred.

Preferred monomers of group B5 are those of group B5A, and also vinylaromatic monomers of group B5B.

It is preferred to employ acrylonitrile or methacrylonitrile, preferably acrylonitrile, as component B5A.

Preferred as component B5B are styrene and α-methylstyrene, styrene being especially preferred.

In a preferred embodiment, acrylonitrile is employed as monomer of component B5 for the preparation of the acrylate binder.

The acrylate binder (B) is obtainable by emulsion polymerization of (data in % by weight are in each case based on the total amount of B):
b1) 20 to 93% by weight, preferably 50 to 90% by weight, especially preferably 60 to 90% by weight, in particular 75 to 85% by weight, of component B1;
b2) 1 to 5% by weight, preferably 1.5 to 3% by weight of component B2;
b3) 0.2 to 5% by weight, preferably 0.5 to 4% by weight, especially preferably 0.75 to 4% by weight, in particular 1 to 3% by weight of component B3;
b4) 0 to 7% by weight, preferably 0 to 5% by weight, especially preferably 0 to 4.5% by weight, in particular 0 or 0.2 to 4.5% by weight of component B4 and
b5) 0 to 40% by weight, preferably 5 to 40% by weight, especially preferably 5 to 30% by weight, in particular 0 or 5 to 26% by weight of component B5.

Suitable processes are known to the skilled worker and described, for example, in WO 2005/064072 (page 20, line 20 to page 23, line 15).

The weight-average molecular weight of the non-crosslinked emulsion polymers obtained is generally between 40 000 and 250 000 (as determined by GPC (gel permeation chromatography)). The molecular weight is generally adjusted by using chain termination reagents, for example organosulfur compounds, in the usual amounts.

The especially preferred acrylate binder is generally obtained in the form of an aqueous dispersion and is usually employed in this form in the insecticidal formulation according to the invention.

The preferred acrylate binder can furthermore comprise usual additives known to the skilled worker, for example film formers and/or plasticizers, such as adipates, phthalates, butyl diglycol, mixtures of diesters, obtainable by reacting dicarboxylic acids with straight-chain or branched alcohols. Suitable dicarboxylic acids and alcohols are known to the skilled worker.

Others which are suitable, apart from the abovementioned binders, are silicone oils and silicone waxes, polysiloxanes, resins with fluorinated hydrocarbon radicals, melamine/formaldehyde condensates, methylolurea derivatives and curable polyesters, with silicone oils being preferred.

The preferred silicone oils and silicone waxes generally take the form of linear or cyclic polyorganosiloxanes, preferably polyalkyl- and/or polyphenylsiloxanes, alkyl being for example methyl, ethyl, propyl or octyl, preferably methyl. Particularly preferred are polydimethylsiloxanes, poly(methylphenylsiloxanes) and corresponding compounds in which a proportion of the methyl groups is replaced by higher alkyl groups. The molecular weight is preferably between 1000 and 150 000. If appropriate, the silicone oils and in particular the silicone waxes may comprise consistency regulators, for example metal soaps such as lithium stearate, highly-disperse silica, PTFE, boron nitride or urea, in order to obtain a pasty or fatty consistency.

To prepare the sheet-like structures according to the invention, in particular nets, the binders may be employed in the form of a formulation in a solvent, preferably as an aqueous formulation. However, the invention also comprises the use of solvent-free formulations.

In a preferred embodiment, aqueous formulations are employed which comprise 55 to 99% by weight of water, preferably 85 to 98% by weight of water and 1 to 45% by weight, preferably 2 to 15% by weight, of solids, the quantities given being in each case based on the total of all components in the formulation. The precise concentration also depends on the adsorptivity of the textile substrate.

The solids take the form of at least one binder, the insecticidal mixture, optionally at least one crosslinker and optionally further components.

It is preferred to employ at least one water-dispersible crosslinker. In particular in the case of the preferred acrylate binder, this may preferably take the form of a crosslinker which has free isocyanate groups. These may preferably take the form of isocyanurates which have free isocyanate groups, preferably isocyanurates which are derived from aliphatic, cycloaliphatic or aromatic diisocyanates having 4 to 12 carbon atoms. Examples comprise 1,6-hexamethylene diisocyanate, 1,12-dodecane diisocyanate, 2,2′- and 2,4′-dicyclohexylmethane diisocyanate or 2,4-tolyl diisocyanate. Preferred are isocyanurates based on 1,6-hexamethylene diisocyanate. Especially preferred are isocyanurates which have additional hydrophilic groups such as, in particular, polyethylene oxide groups. The preparation of such isocyanurates is known to the skilled worker. They are preferably employed as a solution in polar aprotic solvents such as, for example, ethylene carbonate or propylene carbonate. Further details on the preferred crosslinkers having isocyanate groups are disclosed in WO 2008/052913 page 34, line 6 to page 35, line 3. It is especially preferred to employ an isocyanurate which is based on 1,6-hexamethylene diisocyanate (HMDI) and which has additional polyethylene oxide groups, the isocyanurate being dissolved in propylene carbonate (70% by weight of HMDI in propylene carbonate). The free isocyanate groups amount to approximately 11 to 12% by weight based on the solution. The crosslinker is preferably employed in an amount of from 1 to 10% by weight based on the amount of all solids of the formulation. The isocyanurate-based crosslinkers are suitable especially for crosslinking the above-named copolymers.

The formulation may furthermore comprise typical additives and adjuvants, UV stabilizers and colorants. Examples of such additives are mentioned in WO 2008/052913 page 35, line 17 to page 37, line 5.

Besides serving purely esthetic purposes, colorants and pigments may have a warning effect for example on birds or mammals, or may bring about a camouflage effect of the insecticidal nets against insects. Moreover, dark colors may bring about shading, which may be desired, and may reduce the harmful effect of UV light on active compounds and textile fibers when used in the open.

Crosslinkers and thickeners may be employed to enable uniform coating with the treatment liquor of sheet-like structures which can only be wetted with difficulty, and therefore inhomogeneously, such as, for example, polyolefin fibers. For this purpose, it would also be possible to employ water-miscible solvents, which, however, is not preferred due to the harmful effect on the environment. A person skilled in the art is familiar with the adjuvants which are conventionally used and with their concentrations.

The formulations may preferably comprise antioxidants, peroxide scavengers, UV absorbers and light stabilizers. This is particularly recommended in the case of nets which are exposed to increased UV irradiation in the open or in greenhouses. The abovementioned additives protect not only the substrate fibers, but also the active compounds, from decomposition due to radiation.

Suitable UV absorbers are described for example in WO 02/46503 or in WO 2007/077101. UV absorbers may firstly be used as a component in the formulation for finishing; secondly, they may also be incorporated as early as during the production of the fibers, for example in the case of polyolefins and polyesters. It is also possible advantageously to employ mixtures of a plurality of stabilizers which have different protective effects. As a rule, from 0.2 to 5% by weight, preferably from 0.25 to 4% and very especially preferably from 0.5 to 3.5% by weight of stabilizer is employed based on the weight of the untreated net. The amount in the formulation will be adjusted by the skilled worker to suit the task in hand.

Finishing According to Variant B by Incorporating the Insecticide Mixture into Monofilaments

In a further embodiment of the invention, finishing is carried out by directly incorporating the mixture according to the invention into a monofilament which is processed for example to give fibers, of which the sheet-like structure according to the invention consists or which are present therein. Preferably, the sheet-like structure in this variant is a net.

A suitable polymer material for the monofilament into which the mixture according to the invention can be incorporated are thermo plastic polymers, preferably those based on olefinically unsaturated monomers, for example polyolefins, polyvinyl chloride, polyvinyl alcohols, poly(meth)acrylates, but also polyesters and polycarbontes, and, if appropriate, mixtures of the abovementioned polymers with each other or with thermoplastic elastomers. Especially preferred are polyethylene, for example low-density polyethylene (LDPE), such as linear low-density polyethylene (LLDPE), ultra-low density polyethylene (ULDPE), medium-density polyethylene (MDPE) and high-density polyethylene (HDPE), polyethylene resins such as copolymers of ethylene and alpha-olefins with at least three carbon atoms, polypropylene homopolymers, random copolymers and block copolymers of propylene and alpha-olefins with four and more carbon atoms, copolymers of ethylene with unsaturated carboxylic acid compounds, for example poly(ethylene/methyl methacrylate), poly(ethylene/vinyl acetate) or poly(ethylene/acrylic acid), and mixtures of such polymers and copolymers. Examples of thermoplastic elastomers comprise olefin- and styrene-based thermoplastic elastomers. Preferred are copolymers with ethylene or propylene as the main component, but also block copolymers comprising polystyrene and polyisoprene and/or polybutadiene blocks, and hydrogenated derivatives of such copolymers.

To produce the monofilaments which comprise the insecticide mixture according to the invention in a thermoplastic polymer matrix, the insecticide mixture and the polymer may be mixed by melt-kneading. It is also possible first to prepare a masterbatch by melt-kneading suitable amounts of insecticide mixture and polymer, which masterbatch is subsequently diluted to the desired concentration by melt-kneading with a further quantity of polymer. If the masterbatch method is employed, it is also possible to use different polymers for the masterbatch and for the subsequent dilution, for example an LLDPE for the masterbatch and an HDPE for diluting the masterbatch.

Besides the polymer and the insecticide mixture according to the invention, the polymer composition comprises, if appropriate, a pulverulent carrier material, preferably from the group of the talcs, kaolin, loams, finely-pulverulent SiO₂, carbon and dextrins. The pulverulent carrier material, if present, amounts to preferably from 0.01 to 10% by weight. The pulverulent carrier material can be mixed with the insecticide mixture and the polymer by melt-kneading, but it is preferred first to mix the insecticide mixture and the pulverulent material and subsequently to mix this mixture with the polymer, for example by melt-kneading. It is especially preferred to use a mixture of the pulverulent material and the insecticide mixture for preparing a masterbatch.

Besides polymer, insecticide mixture and, if appropriate, pulverulent carrier, the polymer composition comprises, if appropriate, customary additives to thermoplastic molding compositions, such as pigments, antioxidants, lubricants and the like.

To produce the filaments according to these embodiments of the invention, a mixture is prepared of, for example, polymer, insecticide mixture and, if appropriate, further additives by melt-kneading, preferably at elevated temperatures, the mixture is extruded and the extrudate is processed to give pellets. Such pellets can be drawn by melt-spinning, by the extrusion method, to give a filament from which nets according to the invention can be woven, for example by the Raschel method.

Details on netting material and its production for this embodiment of the invention are described for example in WO 2008/004711.

### Properties and Use of the Sheet-Like Structures According to the Invention

Sheet-like structures according to the invention, in particular nets, are suitable for protecting humans and domestic animals from harmful insects and from vector-transmitted diseases which are transmitted by the harmful insects.

Sheet-like structures according to the invention are also suitable for controlling harmful insects, wherein the sheet-like structure according to the invention, preferably in the form of a net, is applied in a building. In a preferred embodiment of the method according to the invention, a flexible sheet-like structure according to the invention, in particular a net, is applied around a live being or a nonlive object which, being a potential source of food, attracts the harmful insects.

The term harmful insects comprises according to the invention not only insects per se, but also harmful arachnids (Arachnida), in particular those which, being vectors, are responsible for transmitting diseases.

The sheet-like structures according to the invention are suitable in particular for protecting against, or controlling, hygiene pests and stored-product pests from the orders Diptera, Siphonaptera, Blattaria, (Blattodea), Dermaptera, Hemiptera, Hymenoptera, Orthoptera, Isoptera, Thysanura, Phthiaraptera, Araneida and Acarina, and the classes Chilopoda and Diplopoda. They are preferably suitable against Diptera, Hemiptera, Hymenoptera, Acarina and Siphonaptera.

In particular, they are suitable against Diptera, such as Culicidae, Simuliidae, Ceratopogonidae, Tabanidae, Muscidae, Calliphoridae, Oestridae, Sarcophagidae, Hippoboscidae, Siphonaptera (Pulicidae, Rhopalopsyllidae, Ceratophyllidae) and Acarina (Ixodidae, Argasidae, Nuttalliellidae), in particular against mosquitoes and flies.

In particular, the substrates according to the invention are suitable against:

Centipedes (Chilopoda), for example Scutigera coleoptrata,

Millipedes (Diplopoda), for example Narceus spp.,

Spiders (Araneae), for example Latrodectus mactans and Loxosceles reclusa,

Mites (Acaridida), for example Sarcoptes sp.

Parasitic mites (Parasitiformes): ticks (Ixodida), for example Ixodes scapularis, Ixodes holocyclus, Ixodes pacificus, Rhiphicephalus sanguineus, Dermacentor andersoni, Dermacentor variabilis, Amblyomma americanum, Ambryomma maculatum, Ornithodorus hermsi, Ornithodorus turicata and Mesostigmata, for example Ornithonyssus bacoti and Dermanyssus gallinae,

Termites (Isoptera), for example Calotermes flavicollis, Leucotermes flavipes, Heterotermes aureus, Reticulitermes flavipes, Reticulitermes virginicus, Reticulitermes lucifugus, Termes natalensis and Coptotermes formosanus,

Cockroaches (Blattaria—Blattodea), for example Blattella germanica, Blattella asahinae, Periplaneta americana, Periplaneta japonica, Periplaneta brunnea, Periplaneta fuligginosa, Periplaneta australasiae and Blatta orientalis,

Dipterans (Diptera), such as flies and midges, for example Aedes aegypti Aedes albopictus, Aedes vexans, Anastrepha ludens, Anopheles maculipennis, Anopheles crucians, Anopheles albimanus, Anopheles gambiae, Anopheles freeborni, Anopheles leucosphyrus, Anopheles minimus, Anopheles quadrimaculatus, Calliphora vicina, Chrysomya bezziana, Chrysomya hominivorax, Chrysomya macellaria, Chrysops discalis, Chrysops silacea, Chrysops atlanticus, Cochliomyia hominivorax, Cordylobia anthropophaga, Culicoides furens, Culex pipiens, Culex nigripalpus, Culex quinquefasciatus, Culex tarsalis, Culiseta inornata, Culiseta melanura, Dermatobia hominis, Fannia canicularis, Gasterophilus intestinalis, Glossina morsitans, Glossina palpalis, Glossina fuscipes, Glossina tachinoides, Haematobia irritans, Haplodiplosis equestris, Hippelates spp., Hypoderma lineata, Leptoconops torrens, Lucilia caprina, Lucilia cuprina, Lucilia sericata, Lycoria pectoralis, Mansonia spp., Musca domestica, Muscina stabulans, Oestrus ovis, Phlebotomus argentipes, Psorophora columbiae, Psorophora discolor, Prosimulium mixtum, Sarcophaga haemorrhoidalis, Sarcophaga sp., Simulium vittatum, Stomoxys calcitrans, Tabanus bovinus, Tabanus atratus, Tabanus lineola and Tabanus similis,

Earwigs (Dermaptera), for example Forficula auricularia,

Hemipterans (Hemiptera), such as lice and bugs, for example Cimex lectularius, Cimex hemipterus, Reduvius senilis, Triatoma spp., Rhodnius prolixus and Arilus critatus,

Hymenopterans (Hymenoptera), such as ants, bees, wasps and plant wasps, for example Crematogaster spp., Hoplocampa minuta, Hoplocampa testudinea, Monomorium pharaonis, Solenopsis geminata, Solenopsis invicta, Solenopsis richteri, Solenopsis xyloni, Pogonomyrmex barbatus, Pogonomyrmex californicus, Dasymutilla occidentalis, Bombus spp. Vespula squamosa, Paravespula vulgaris, Paravespula pennsylvanica, Paravespula germanica, Dolichovespula maculata, Vespa crabro, Polistes rubiginosa, Camponotus floridanus and Linepithema humile,

Orthopterans (Orthoptera), such as crickets, grasshoppers and locusts, for example Acheta domestica, Gryllotalpa gryllotalpa, Locusta migratoria, Melanoplus bivittatus, Melanoplus femurrubrum, Melanoplus mexicanus, Melanoplus sanguinipes, Melanoplus spretus, Nomadacris septemfasciata, Schistocerca americana, Schistocerca gregaria, Dociostaurus maroccanus, Tachycines asynamorus, Oedaleus senegalensis, Zonozerus variegatus, Hieroglyphus daganensis, Kraussaria angulifera, Calliptamus italicus, Chortoicetes terminifera and Locustana pardalina,

Fleas (Siphonaptera), for example Ctenocephalides felis, Ctenocephalides canis, Xenopsylla cheopis, Pulex irritans, Tunga penetrans and Nosopsyllus fasciatus,

Bristletails (Thysanura), such as silverfish and firebrats, for example Lepisma saccharina and Thermobia domestica,

Lice (Phthiraptera), for example Pediculus humanus capitis, Pediculus humanus corporis, Pthirus pubis, Haematopinus eurysternus, Haematopinus suis, Linognathus vituli; Bovicola bovis, Menopon gallinae, Menacanthus stramineus and Solenopotes capillatus.

The substrate according to the invention is especially preferably suitable for protecting against, or controlling, mosquitoes (Culicidae), in particular of the genera Anopheles, such as Anopheles gambiae, Anopheles stephensi, Anopheles funestus, Anopheles maculipennis, Anopheles claviger and Anopheles plumbeus; Aedes, such as Aedes aegypti (Stegomyia aegypti), Aedes albopictus; Culex, such as Culex quinquefasciatus; Culiseta; Haemagoggus; Mansonia; Ochlerotatus; Psorophora; Sabethes; Toxorhynchites; Verralina; Wyeomyia and Zeugnomyia.

The sheet-like structures according to the invention are furthermore preferably suitable for protecting against, or controlling, Siphonaptera (fleas), in particular Tunga (sand fleas), such as Tunga penetrans.

Sheet-like structures according to the invention, in particular nets, are especially preferably suitable for controlling harmful insects which display resistance either to pyrethroids or to chlorfenapyr, preferably pyrethroids.

Diseases whose transmission can be prevented are, besides diseases brought on by plasmodia, such as, for example, malaria tropicana, malaria tertiana and malaria quartana, also diseases which are brought on by parasitic worms, for example filariosis, disofilariosis, diseases brought on by viruses, for example yellow fever, dengue fever, Western Nile fever, Chikungunya fever, Rift Valley fever, diseases brought on by bacteria, for example tularemia and Chagas disease (South American trypanosomiasis), which is caused by the parasitic single-celled organism Trypanosoma cruzi and transmitted by predatory bugs.

In addition, the sheet-like structures according to the invention, in particular nets, are also suitable for protecting crops to be stored, that is to say harvested plants or plant parts, if appropriate also in processed form.

They can be employed for example by wrapping the goods to be protected in the nets. The goods to be protected may, for example, take the form of wood stacks, fruit, vegetables, cereals, cocoa beans, coffee beans or spices. The goods may furthermore take the form of bales. Examples comprise bales selected from the group consisting of tea, tobacco or cotton.

The invention is illustrated in greater detail by the examples without being limited thereby.

### EXAMPLES

### A) Acrylate Binder

### Preparation of the Polymer Dispersions

### General Procedure

250 g of water and 3 g of styrene Saatlatex (33% by weight) with a mean particle size of 30 nm are heated to 85° C., whereupon 5% by weight of the feed 2 are added. After 10 min, the addition of feed 1 (see below) and the remainder of feed 2 starts.

Feed 2 comprises 30 g of sodium peroxydisulfate dissolved in 39.9 g of H₂O. The composition of feed 1 is shown in table 1. Feeds 1 and 2 are added in the course of 3 hours, followed by after polymerization for 0.5 hour.

TABLE 1
Composition of feed 1 in % by weight pphm (parts per hundred monomers)

| Monomer | | | | | | | | | | |
|---|---|---|---|---|---|---|---|---|---|---|
| composition | MMA | S | AN | EHA | BA | EA | MaMol | AMol | AM | AS |
| A1 | | 16.6 | | 30.0 | 30.0 | 20.0 | | 3.0 | | 0.4 |
| A2 | 25.7 | 5.0 | | 5.3 | 60.0 | | 3.5 | | | 0.5 |
| A3 | | 14.7 | 11.0 | | 70.0 | | 3.5 | | 0.5 | 0.3 |
| A4 | 30.0 | 13.0 | 8.0 | | 45.2 | | | 3.0 | 0.5 | 0.3 |
| A5 | 20.0 | 20.0 | | 17.0 | 23.0 | 15.3 | 3.5 | | | 1.2 |
| A6 | 26.0 | | 13.0 | | 57.0 | | 3.0 | | | 1.0 |
| A7 | 15.0 | | 13.0 | | 68.0 | | 3.0 | | | 1.0 |
| A8 | | | 16.0 | | 81.0 | | 2.0 | | | 1.0 |

The amount of the initiator sodium peroxydisulfate is 0.3 parts by weight, that of the emulsifier 0.4 parts by weight of Dowfax 2A1 (Dow) and 0.6 parts by weight of Lumiten IRA (BASF SE), based on 100 parts by weight of the monomer composition of table 1.

### ABBREVIATIONS

MMA: Methyl methacrylate
S: Styrene
AN: Acrylonitrile
EA: Ethyl acrylate
EHA: 2-Ethylhexyl acrylate
BA: n-Butyl acrylate
Amol: N-Methylolacrylamide
MAMol: N-Methylolmethacrylamide
AS: Acrylic acid
AM: Acrylamide

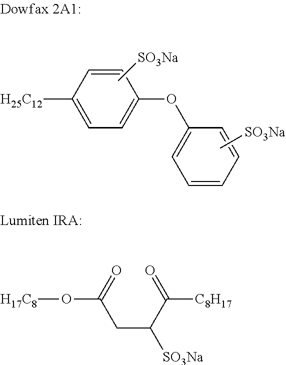

### B) Production of the Nets Used (Variant A with Binder)

TABLE 2

| | | Alpha- | | | | |
|---|---|---|---|---|---|---|
| | | cypermethrin | | Chlorfenapyr | Acrylate | Acrylate binder |
| | Alpha- | bath | | bath | binder A8 | A8 bath |
| | cypermethrin | concentration | Chlorfenapyr | concentration | weight on the | concentration |
| | [mg/m²] | [g/l] | [mg/m²] | [g/l] | net [%] | [g/l] |
| Net 1 | 100 | 3.2 | 0 | 0 | 0.55 | 5 |
| Net 2 | 100 | 3.2 | 100 | 3.2 | 1 | 10 |
| Net 3 | 0 | 0 | 100 | 3.2 | 0.55 | 5 |

Each of the nets employed for the experiments were finished with an aqueous formulation of the insecticide alpha-cypermethrin, the insecticide chlorfenapyr, the acrylate binder A8 and an isocyanate-based crosslinker, dried and crosslinked for 1 min at approximately 100° C. The amount of insecticide as shown in table 2 is adjusted by determining the liquid uptake of the net (if appropriate after squeezing under defined conditions), and the concentration of the formulation is adjusted so that the desired amount per square meter on the net results. The amount of binder was adapted to match the insecticide content.

### C) Testing the Nets

The treated nets were washed repeatedly as shown in table 3. Washing was effected according to the procedure “Montpellier washing procedure” (as described in the appendix WHO PVC, Mar. 7, 2002 “Evaluation of wash resistance of long-lasting insecticidal nets”). The procedure was carried out as specified in WO 2005/064072, page 46.

The samples were subjected to biological testing as specified in WO 2005/064072, page 47. This biological testing corresponds to the WHO “Cone Test” (WHOPES 96.1), with minor adaptations. The data determined were the “knock-down” after 60 minutes and the mortality after 24 hours.

The test organisms employed for the experiments were firstly an Aedes aegypti strain which was not resistant to pyrethroids and secondly a pyrethroid-resistant Anopheles gambiae strain.

TABLE 3

| | | Aedes | Aedes | Anopheles | Anopheles |
|---|---|---|---|---|---|
| | | aegypti | aegypti | gambiae | gambiae |
| | Washes | % KD | % Mortality | % KD | % Mortality |
| Net 1 | 0 | 100 | 100 | 20 | 40 |
| Net 1 | 20 | 98 | 96 | 15 | 38 |
| Net 2 | 0 | 98 | 95 | 96 | 90 |
| Net 2 | 20 | 100 | 100 | 100 | 85 |
| Net 3 | 0 | 100 | 92 | 90 | 85 |
| Net 3 | 20 | 98 | 98 | 85 | 80 |

The results demonstrate that nets according to the invention show a good effect, even against pyrethroid-resistant Anopheles mosquitoes.

1-15. (canceled)

16. A sheet-like structure finished with an insecticidal mixture comprising
a) chlorfenapyr and
b) one or more pyrethroids from the group consisting of alpha-cypermethrin (b1), deltamethrin (b2), permethrin (b3) and lambda-cyhalothrin (b4),
in an amount of (in each case relative to the sheet-like structure)
a) 50 to 150 mg/m² chlorfenapyr;
b1) 50 to 150 mg/m² alpha-cypermethrin;
b2) 15 to 45 mg/m² deltamethrin;
b3) 50 to 750 mg/m² permethrin;
b4) 5 to 30 mg/m² lambda-cyhalothrin.

17. The sheet-like structure as claimed in claim 16, wherein the amount of chlorfenapyr is from 70 to 130 mg/m².

18. The sheet-like structure as claimed in claim 16, wherein the pyrethroid is alpha-cypermethrin in an amount of from 70 to 130 mg/m².

19. The sheet-like structure as claimed in claim 16, wherein the pyrethroid is deltamethrin in an amount of from 20 to 40 mg/m².

20. The sheet-like structure as claimed in claim 16, wherein the pyrethroid is permethrin in an amount of from 75 to 650 mg/m².

21. The sheet-like structure as claimed in claim 16, wherein the pyrethroid is lambda-cyhalothrin in an amount of from 7.5 to 25 mg/m².

22. The sheet-like structure as claimed in claim 17, wherein the pyrethroid is alpha-cypermethrin in an amount of from 70 to 130 mg/m².

23. The sheet-like structure as claimed in claim 17, wherein the pyrethroid is deltamethrin in an amount of from 20 to 40 mg/m².

24. The sheet-like structure as claimed in claim 17, wherein the pyrethroid is permethrin in an amount of from 75 to 650 mg/m².

25. The sheet-like structure as claimed in claim 17, wherein the pyrethroid is lambda-cyhalothrin in an amount of from 7.5 to 25 mg/m².

26. The sheet-like structure as claimed in claim 16, wherein the finishing is a coating with a mixture of insecticide mixture according to the invention and a binder.

27. The sheet-like structure as claimed in claim 16, wherein, for finishing purposes, the insecticidal mixture is incorporated into a monofilament which is present in the sheet-like structure.

28. The sheet-like structure as claimed in claim 16 in the form of a textile material.

29. The sheet-like structure as claimed in claim 16 in the form of a net.

30. A method of protecting humans and/or domestic animals from harmful insects, which comprises applying the sheet-like structure as claimed in claim 16 in a building which is used by the humans and/or the domestic animals.

31. A method of protecting humans and/or domestic animals from vector-transmitted diseases which are transmitted by harmful insects, which comprises applying the sheet-like structure as claimed in claim 16 in a building which is used by the humans and/or the domestic animals.

32. A method of controlling harmful insects in a building which comprises applying the sheet-like structure as claimed in claim 16 in the building.

33. The method as claimed in claim 30, wherein the harmful insects display a pyrethroid resistance.

34. The method as claimed in claim 31, wherein the harmful insects display a pyrethroid resistance.

35. The method as claimed in claim 32, wherein the harmful insects display a pyrethroid resistance.
